(19) United States
(12) Patent Application Publication
(10) Pub. No.: US 2007/0005708 A1
(43) Pub. Date: Jan. 4, 2007

(54) Authorizing control for electronic communications

(76) Inventor: Cornell Juliano, Churchville, NY (US)

Correspondence Address: Alix, Yale & Ristas, LLP, 750 Main Street, Hartford, CT, 06103, US

(21) Appl. No.: 11/157,590

(22) Filed: Jun. 21, 2005

(51) Int. Cl. G06F 15/16

(52) U.S. Cl. 709/206

(57) ABSTRACT

An e-mail system includes an authorization control configurable to compare outgoing e-mail addresses with a list of authorized recipients. The authorization control aids in preventing transmission of e-mail to unintended recipients. The authorization control is configurable for use in a range of security environments.

### TECHNICAL FIELD

The present application generally relates to electronic communications and more particularly to electronic mail.

### BACKGROUND

Electronic mail, or e-mail, refers to a service that transmits electronic messages from one computer to another. These messages may be simple text messages or more complex messages containing documents and data of various types. The transmission of e-mail messages may range from transmission over a short distance, such as over a local area network between employees in adjoining offices, to transmission over extremely long distances, such as over the global Internet between users on different continents. Most e-mail traffic is delivered via the Internet. Businesses and individuals typically lease access to the Internet from Internet Service Providers (ISPs). ISPs maintain mail servers that handle e-mail for their customers. E-mail capability may be one feature of an e-mail capable system, built into a multi-purpose software suite or may be provided by a stand-alone application resident on a computer system.

More and more users globally are communicating via e-mail, which is considerably less expensive than regular telephone or other related communication systems. E-mail offers numerous advantages over other forms of communication. For example, e-mail is less intrusive than a telephone call because the recipient of an e-mail message may wait until a convenient time to retrieve and respond to the message rather than being immediately interrupted. Another advantage of e-mail is the ability to communicate with large groups of people by sending a single e-mail message to multiple recipients. This is typically accomplished by using a feature called a distribution list. Still another advantage of e-mail is the ability to send many different types of documents, data and information within the e-mail or as electronic attachments to an e-mail message.

Generally, to send an e-mail message, a user opens an e-mail program module and types a message and other information into an e-mail form. The e-mail form contains a number of fields for the recipients' addresses, the subject of the message, and the message itself. The e-mail program typically includes commands in the form of verbs that a form is capable of executing. Typical verbs may include commands such as “reply”, “forward”, “open”, “send” and “print”. The user may also attach separate files to the e-mail message using an “attach file” command or the like. Before sending the e-mail message, the user must enter the recipient's e-mail address, which is used by the e-mail system to route the message to the intended recipient. E-mail addresses typically have two main parts: first a user name that refers to the recipient's mailbox and then the “host name” or “domain name” referring to the mail server where the recipient has an electronic mailbox. The two parts of the address are separated by the “at” sign (@).

Frequently, users correspond with many recipients and need to maintain a collection of addresses to avoid looking for and re-typing e-mail addresses each time a communication is sent. Most e-mail programs include an “address book” component that allows users to accumulate and organize the addresses of recipients with whom they correspond. E-mail programs also allow users to designate groups of e-mail addresses selected from the address book as a “distribution list” or “recipient list”. A distribution list allows the user to send the same message to all addresses included in the distribution list without physically collecting and inserting the addresses in the “to” field of the message form or repeatedly sending the same message to each intended recipient. The distribution list may be in the form of a mailing list program, or an alias in an e-mail program representative of the distribution list. A distribution list may consist of a single address, a collection of addresses or even a collection of other distribution lists.

After composing an e-mail message and entering the recipient's address, the user sends the message by invoking a “send” command. The e-mail system then sends the message to the recipient. The outgoing e-mail is transmitted to a Simple Mail Transfer Protocol (SMTP) server maintained by the user's ISP. The server looks at the e-mail address and forwards the message to the recipient's server, called a Post Office Protocol (POP) server, where it is stored in the appropriate mail box until the addressee (intended recipient) calls for it. At the recipient's computer, the recipient typically will receive a visual or auditory cue, such as a ringing bell, when an e-mail message arrived in the recipient's inbox. The recipient may then use their e-mail program to view a list of the messages in the inbox. The recipient may view the complete text of a message by selecting and opening that message. Any attachments may also be opened using an appropriate software application, such as a word processing program, an image viewing program, a document viewing program, or the like.

Although e-mail provides a valuable and useful tool, current e-mail systems are not without their drawbacks. For instance, many e-mail addresses are very similar, with only one letter or number difference and many e-mail addresses are variations on common names associated with widely used e-mail providers. Because the address must be specific, a typographical error or erroneous domain name entered in the address field will result in the message being mis-delivered or not delivered at all.

Recent changes in federal and state law impose potentially severe penalties on banks, health care providers and others for release of certain types of personal information. Once the “send” action is taken in the typical e-mail program, it is impossible to retrieve the message. Some personnel send many e-mail messages every day, and information can be included in or attached to each e-mail, presenting the very real hazard that an e-mail containing sensitive information may be misdirected, e.g., sent to an unintended recipient. Some banking information in the wrong hands can lead to fraud or identity theft. Disclosure of other types of information can be embarrassing to the person to whom the information relates. Further, the institution charged with maintaining the security of the information can be subjected to adverse publicity and threatened with prosecution.

There is a need for methods and systems that will help avoid the inadvertent or unauthorized release of private, proprietary, secure or otherwise sensitive information by misdirected e-mail.

### SUMMARY

According to aspects illustrated herein, there is provided a method for authorizing distribution of e-mail in an e-mail messaging system for users of an e-mail capable system such as a computer system handling one or more types of sensitive information. The method comprises assembling an authorization list including e-mail addresses of persons or entities authorized to receive each type of sensitive information. Each outgoing e-mail is associated with at least one authorization list. The e-mail address of each outgoing e-mail is compared to at least one authorization list. The e-mail is sent to the addressee if the e-mail address is included in at least one authorization list. An alert is produced if the e-mail address is not included in at least one authorization list and a further action is required before sending the e-mail.

According to aspects described herein, there is provided an e-mail capable system providing e-mail service comprising a memory, a user interface including a display and input devices, a processor functionally connected to the memory and the user interface, and an e-mail program resident in the memory for handling incoming and outgoing e-mails. The e-mail program is responsive to the input devices to generate an e-mail form on the display. The e-mail form includes at least an address field and a content field. The e-mail program includes an authorization module configurable to compare an e-mail address of each outgoing e-mail to an authorization list of e-mail addresses authorized to receive e-mail from the e-mail capable system. The e-mail program is configured to instruct the processor to perform operations including sending the outgoing e-mail if the e-mail address is included in the authorization list. An alert is produced if the e-mail address is not included in the authorization list and a further action is required before sending the outgoing e-mail.

A further disclosed embodiment is a computer program product for use in a computer-implemented process for authorizing the distribution of e-mail containing one or more types of sensitive information from an e-mail capable system. The computer program product comprises a medium readable by a computer. The computer readable medium has computer program code adapted for assembling an authorization list including e-mail addresses of persons or entities authorized to receive each type of sensitive information; associating each outgoing e-mail with at least one authorization list; comparing an e-mail address of each outgoing e-mail to at least one authorization list; sending the outgoing e-mail to the addressee if the e-mail address is included in at least one authorization list; or producing an alert if the e-mail address is not included in at least one authorization list; and requiring a further action before sending the outgoing e-mail.

### BRIEF DESCRIPTION OF THE DRAWINGS

FIG. 1 illustrates an exemplary e-mail capable system suitable as an operating environment for the disclosed embodiments;

FIG. 2 illustrates an e-mail form according to aspects of the disclosed embodiments;

FIG. 3 illustrates an exemplary host system that provides e-mail services compatible with the disclosed embodiments;

FIG. 4 is a flow chart illustrating a disclosed exemplary method embodiment;

FIG. 5 is a flow chart illustrating sub-components of a disclosed exemplary method embodiment; and

FIGS. 6 and 7 are flow charts illustrating further disclosed sub-components of disclosed exemplary methods.

### DETAILED DESCRIPTION

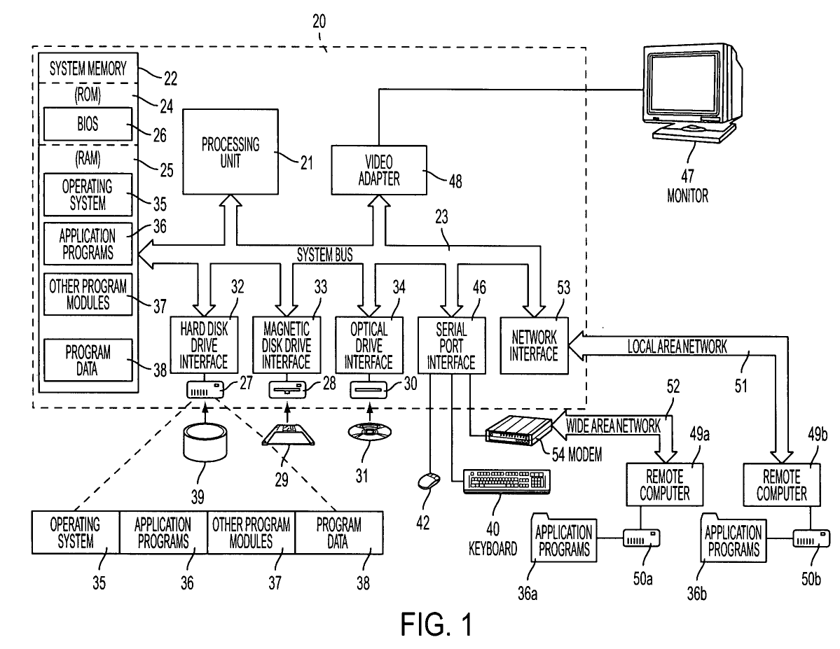

The disclosed embodiments will be described in the general context of computer-executable instructions, such as program modules, being executed by a computer. FIG. 1 and the following discussion are intended to provide a brief, general description of a suitable computing environment in which the embodiment may be implemented. Although not required, the disclosed embodiments will be described in the general context of computer-executable instructions, such as program modules, being executed by devices in network environments. Generally, program modules include routines, programs, objects, components, data structures, etc. that perform particular tasks or implement particular abstract data types. Computer-executable instructions, associated data structures, and program modules represent examples of the program code for executing the methods disclosed herein. The particular sequence of such executable instructions or associated data structures represent examples of corresponding acts for implementing the functions described.

Those skilled in the art will appreciate that the disclosed embodiments may be practiced in network environments with many types of e-mail capable system configurations, including personal computers, hand-held devices, multi-processor systems, microprocessor-based or programmable consumer electronics, network PCs, minicomputers, mainframe computers, and the like. The embodiments may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

The embodiments may also be practiced in what may be understood to be non-computer environments. One example of a non-computer device that could be configured to incorporate the embodiment is a network scanner with e-mail. The terms “computer” and “computer system” shall be interpreted broadly to encompass all of the above-described networked or connected devices.

FIG. 1 illustrates an exemplary e-mail capable system suitable as an operating environment for the disclosed embodiments. The exemplary e-mail capable system is a general purpose computing device in the form of a computer 20, including a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read only memory (ROM) 24 and random access memory (RAM) 25. A basic input/output system (BIOS) 26, containing the basic routines that help transfer information between elements within the computer 20, such as during start-up, may be stored in ROM 24.

The computer 20 may also include a magnetic hard disk drive 27 for reading from and writing to a magnetic hard disk 39, a magnetic disk drive 28 for reading from or writing to a removable magnetic disk 29, and an optical disk drive 30 for reading from or writing to removable optical disk 31 such as a CD-ROM or other optical media. The magnetic hard disk drive 27, magnetic disk drive 28, and optical disk drive 30 are connected to the system bus 23 by a hard disk drive interface 32, a magnetic disk drive-interface 33, and an optical drive interface 34, respectively. The drives and their associated computer-readable media provide nonvolatile storage of computer-executable instructions, data structures, program modules and other data for the computer 20. Although the exemplary environment described herein employs a magnetic hard disk 39, a removable magnetic disk 29 and a removable optical disk 31, other types of computer readable media for storing data can be used, including magnetic cassettes, flash memory cards, digital video disks, Bernoulli cartridges, RAMs, ROMs, and the like.

Program code in the form of one or more program modules may be stored on the hard disk 39, magnetic disk 29, optical disk 31, ROM 24 or RAM 25, including an operating system 35, one or more application programs 36, other program modules 37, and program data 38. A user may enter commands and information into the computer 20 through keyboard 40, pointing device 42, or other input devices (not shown), such as a microphone, joy stick, game pad, satellite dish, scanner, or the like. These and other input devices are often connected to the processing unit 21 through a serial port interface 46 coupled to system bus 23. Alternatively, the input devices may be connected by other interfaces, such as a parallel port, a game port or a universal serial bus (USB). A monitor 47 or another display device is also connected to system bus 23 via an interface, such as video adapter 48. In addition to the monitor, personal computers typically include other peripheral output devices (not shown), such as speakers and printers.

The computer 20 may operate in a networked environment using logical connections to one or more remote computers, such as remote computers 49a and 49b. Remote computers 49a and 49b may each be another personal computer, a server, a router, a network PC, a peer device or other common network node, and typically includes many or all of the elements described above relative to the computer 20, although only memory storage devices 50a and 50b and their associated application programs 36a and 36b have been illustrated in FIG. 1. The logical connections depicted in FIG. 1 include a local area network (LAN) 51 and a wide area network (WAN) 52 that are presented here by way of example and not limitation. Such networking environments are commonplace in office-wide or enterprise-wide computer networks, intranets and the Internet.

When used in a LAN networking environment, the computer 20 is connected to the local network 51 through a network interface or adapter 53. When used in a WAN networking environment, the computer 20 typically includes a modem 54, a wireless link or other means for establishing communications over the wide area network 52, such as the Internet. The modem 54, which may be internal or external, is connected to the system bus 23 via the serial port interface 46. In a networked environment, program modules depicted relative to the computer 20, or portions thereof, may be stored in the remote memory storage device. It will be appreciated that the network connections shown are exemplary and other means of establishing a communications link between the computers may be used.

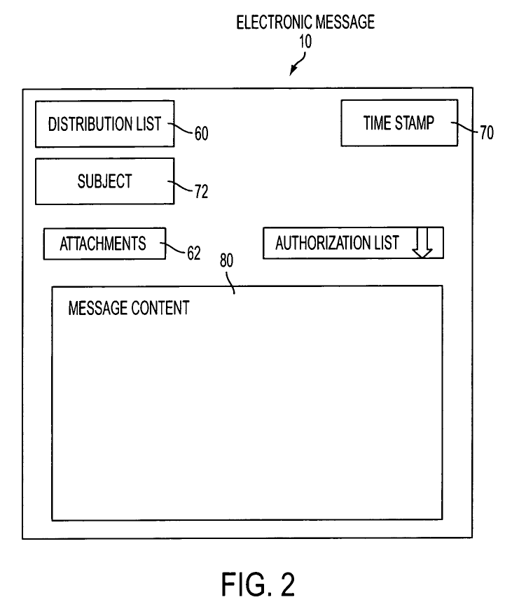

FIG. 2 illustrates the basic elements of an e-mail form 10. Although the disclosed embodiments will be described below in reference to e-mail form 10 of FIG. 2, the disclosed embodiments may alternatively be practiced in conjunction with other electronic messages or forms having more or fewer elements. Specifically, distribution list 60 describes all intended recipients of electronic message 10. Although not shown separately, a distribution list 60 may include direct recipients as well as those receiving normal or blind copies and can be understood to be equivalent to the “to” field commonly used in e-mail forms. Subject 72 is a field where the sender can summarize a message's content. Subject 72 aids recipients in evaluating the relative importance of any particular message without having to review the entire message. Finally, message content 80 represents a message's substantive content and may include minimally formatted text, binary data such as sound, images, executable files, and/or word processing documents, etc., that may be included with a message as an attachment or as the message itself. The e-mail form 10 may also include attachments 62 not included within the content of the message. The e-mail form 10 is also provided with an “Authorization List” drop down menu according to aspects of the disclosed embodiments, the function of which will be described in greater detail below.

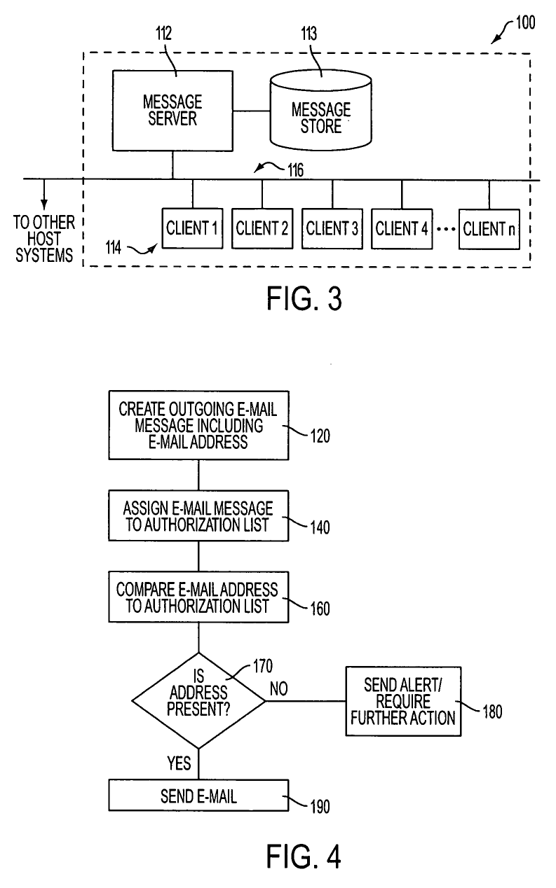

FIG. 3 illustrates one example of a host system that can be used to practice the present embodiment. In general, a host system for the embodiment may be any system that provides electronic messaging services to users, e.g., an e-mail capable system. Host system 100, which should not be seen as imposing any structural or architectural limitations on the disclosed embodiments, includes a message server 112 and clients 114. Message server 112 can be any network server or other computing device capable of managing electronic messaging services for clients 114. In this example, message server 112 is associated with a message store 113, which can be any suitable data storage system capable of storing e-mails, their content and attachments.

In the example of FIG. 3, message server 112 and clients 114 are connected by means of network 1 16, which may be a local area network, or a wide area network. In many cases, network 116 can be an organization-wide LAN configured to provide messaging services to users in the organization. Accordingly, clients 114 can be conventional client systems used in LANs or WANs, or any other suitable computing systems. For instance, clients 114 can be the computer 20 of FIG. 1. As shown in FIG. 3, host system 100 can be linked to other host systems. Host system 100 and, optionally, the other host systems designated by FIG. 3 represent one example of an e-mail capable system.

According to aspects of the disclosed embodiments, there is provided an e-mail program, module, engine, application or the like that incorporates an authorization control feature to verify that messages containing sensitive information are routed only to recipients authorized to receive the sensitive information. Sensitive information means any information to which an organization or individual desires (or is required) to control access. Examples of sensitive information include, but are not limited to: medical information, financial information, account numbers, social security numbers, proprietary technical information, sales information, criminal records, customer information, military information, intelligence information, etc.

According to aspects of the disclosed embodiments, the e-mail application is configured to include authorization lists associated with one or more types of sensitive information. The authorization list is separate from and in addition to any distribution lists in the e-mail application. Each authorization list includes the addresses of recipients authorized to receive a particular type of sensitive information from the e-mail capable system where the e-mail application resides or from a particular client computer 114 as shown in FIG. 3. The e-mail application is adapted to check the address or addresses to which an outgoing message containing sensitive information is being sent against an authorization list associated with that information. If the e-mail address of the outgoing e-mail is not found in the authorization list, the e-mail application will not send the outgoing e-mail until pre-determined action or actions is/are taken. An aspect of the disclosed embodiments relates to sending an alert to the computer attempting to send the message containing the sensitive information to an unauthorized address. The alert may be followed by instructions for taking one or more actions before the message will be sent.

The basic sequence of actions according to aspects of the disclosed embodiments is illustrated in FIG. 4. An outgoing e-mail message including an e-mail address is created at 120. The e-mail is assigned to an authorization list at 140. The address of the outgoing e-mail message is compared to the assigned authorization list at 160. A decision at 170 is made based on the comparison of 160. If the address of the outgoing e-mail is on the assigned authorization list, the e-mail is sent at 190. If the address of the outgoing e-mail is not on the assigned authorization list, the e-mail is not sent, an alert is generated and further action required at 180.

Authorization lists may be locally created or centrally managed, depending on how the embodiment is configured. In a particularly sensitive or secure environment, it may be desirable for the authorization list to be centrally managed and the e-mail application configured to prohibit user-alteration of the list or user-override of the authorization feature. In a less sensitive environment, the embodiment may be configured to permit the user to create and modify authorization lists without additional oversight. A hybrid configuration may require administrator permission or a password to alter an authorization list.

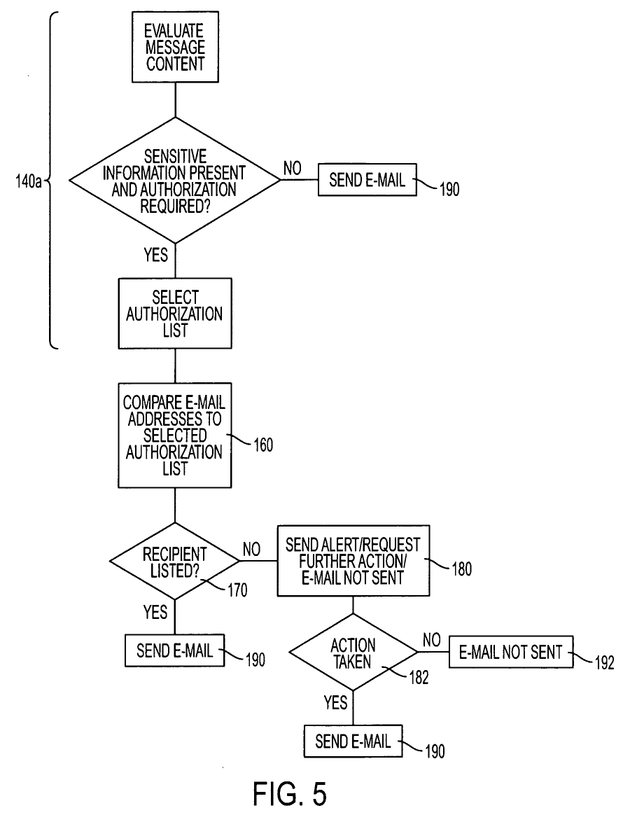

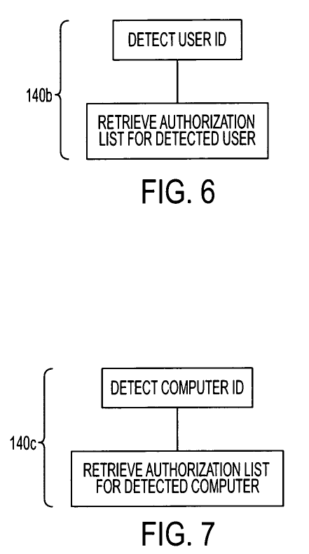

FIG. 5 is a flow chart of an alternative embodiment configured to assign an e-mail message to an authorization list by evaluating the content of the e-mail. In such a configuration, the assignment of an authorization list 140a involves the detection of sensitive information in the e-mail. Sensitive information can be transmitted in the body of an e-mail or as an attachment to the e-mail. The e-mail application may be configured to look for key words, phrases or sequences of letters or numbers in the body of an e-mail and assign an appropriate authorization list accordingly. The source of an attachment, e.g., a database or folder, could be used to assign an authorization list to a message. Alternatively, the e-mail application may require the user to assign the message to an authorization list. FIG. 2 illustrates an authorization list drop-down menu for use by the sender of an e-mail. The designation of an authorization list could be made a mandatory step in sending an e-mail. In a very secure environment, all e-mail would be assumed to contain sensitive information and checked against a closed, centrally managed authorization list, permitting transmission of messages only to those on the authorization list. FIG. 6 illustrates assigning an e-mail message to an authorization list associated with a particular user ID at 140b. FIG. 7 illustrates assigning an e-mail message to an authorization list associated with a particular computer or terminal ID at 140c.

FIG. 5 also illustrates one possible response to an attempt to send an e-mail containing sensitive information to an address not included on the relevant authorization list. At 180, the e-mail is not sent, an alert is generated indicating that the intended recipient is unauthorized to receive the relevant sensitive information and further action is requested. If the further action is taken at 182, the authorization requirement is satisfied and the e-mail is sent at 190. If the requested action is not taken at 182, the e-mail is not sent at 192. The action may be as simple as adding the recipient's address to the appropriate authorization list or overriding the authorization feature. The requested action may be relatively easy for embodiments in low-security environments. The requested action may require a password or independent authorization for embodiments employed in a high security environment.

In all its forms, the authorization feature can help prevent inadvertent, accidental or even malicious transmission of sensitive information to unauthorized recipients by comparing the e-mail addresses of outgoing e-mails with authorization lists and generating an alert when the release of sensitive information by e-mail does not appear to be authorized.

E-mail capable systems can be used to transmit information to other types of communications systems, such as cellular phone and paging networks. An e-mail capable system may be used to send a text message to a cell phone. Text messaging transmits alphanumeric messages to wireless devices such as cell phones, where they are shown on a display. The telephone number of the cell phone forms part of the address for the message. Text messages can be sent from an e-mail program, from some web sites dedicated for this purpose or from another cell phone. When sending a text message from an e-mail program, the telephone number of the intended recipient typically forms the user name or first portion, while the cellular service provider name forms the second “host name” portion of the address. For example, to send a text message to Wonderphone customer (123) 456-7890, the address would be 1234567890@wonderphone.com. A temporary telephone number is assigned to the sender of the message allowing the recipient to respond to the message from their cellular phone. The disclosed embodiment could be incorporated into text messaging systems to apply the authorization feature to exchanges of information between text-enabled wireless devices such as cell phones. The functionality of the disclosed embodiment in the context of a text messaging system would be similar to that disclosed for e-mail capable systems, except that the authorization lists would comprise identifying criteria for authorized recipients of information via the text messaging system, such as telephone numbers and service providers.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. In an e-mail messaging system that provides users of an e-mail capable system with e-mail service, said e-mail capable system handling one or more types of sensitive information, a method for authorizing distribution of e-mail comprising:
assembling an authorization list including e-mail addresses of persons or entities authorized to receive each type of sensitive information;
associating each outgoing e-mail with at least one authorization list;
comparing an e-mail address of each said outgoing e-mail to said at least one authorization list;
sending said e-mail to said addressee if the e-mail address is included in said at least one authorization list; or
producing an alert if said e-mail address is not included in said at least one authorization list; and
requiring a further action before sending said e-mail.

2. The method of claim 1, wherein said associating comprises:
generating a request to designate said at least one authorization list.

3. The method of claim 2, wherein said request to designate is mandatory.

4. The method of claim 1, wherein said associating comprises:
evaluating said e-mail message to detect each type of sensitive information; and
associating said e-mail message with an authorization list for each type of sensitive information detected.

5. The method of claim 1, wherein said e-mail capable system includes a plurality of networked computers and said associating comprises:
designating an authorization list for each of said networked computers; and
said comparing comprises:
comparing each outgoing e-mail from each said networked computer to the authorization list for said networked computer.

6. The method of claim 1, wherein said assembling comprises:
limiting said assembling for one or more types of sensitive information to designated personnel.

7. The method of claim 1, wherein said assembling comprises:
allowing a user of said e-mail capable system to assemble or modify the authorization list for one or more types of sensitive information.

8. The method of claim 1, wherein said requiring a further action comprises:
requiring that said e-mail address is added to said authorization list.

9. The method of claim 1, wherein said requiring a further action comprises:
requiring an explicit override to authorize sending said e-mail.

10. An e-mail capable system providing e-mail service, said e-mail capable system comprising:
a memory;
a user interface including a display and input devices;
a processor functionally connected to said memory and said user interface;
an e-mail program resident in said memory for handling incoming and outgoing e-mails and responsive to said input devices to generate an e-mail form on said display, said e-mail form including at least an address field and a content field, said e-mail program including an authorization module configurable to compare an e-mail address of each outgoing e-mail to an authorization list of e-mail addresses authorized to receive e-mail from said e-mail capable system;
said e-mail program configured to instruct said processor to perform operations including:
sending said outgoing e-mail if the e-mail address is included in said authorization list; or
producing an alert if said e-mail address is not included in said authorization list; and
requiring a further action before sending said outgoing e-mail.

11. The e-mail capable system of claim 10, wherein said authorization module compares the e-mail address of each outgoing e-mail to a plurality of authorization lists, and said operations include:
associating each outgoing e-mail with at least one of said authorization lists.

12. The e-mail capable system of claim 10, wherein said e-mail capable system handles sensitive information and said authorization module includes e-mail addresses of persons or entities authorized to receive said sensitive information, and said authorization module includes an algorithm to evaluate each outgoing e-mail message to detect sensitive information and compares said e-mail address to said authorization list only upon detection of said sensitive information.

13. The e-mail capable system of claim 10, wherein said authorization module includes a plurality of authorization lists and said e-mail form includes a field requiring the designation of at least one authorization list to which the address of an outgoing e-mail message input into said e-mail form will be compared.

14. The e-mail capable system of claim 10, wherein said authorization module allows unrestricted modification of said authorization list.

15. The e-mail capable system of claim 10, wherein said authorization module includes security measures restricting modification of said authorization list.

16. A computer program product for use in a computer-implemented process for authorizing the distribution of e-mail containing one or more types of sensitive information from an e-mail capable system, the computer program product comprising:
a medium readable by a computer, the computer readable medium having computer program code adapted for:
assembling an authorization list including e-mail addresses of persons or entities authorized to receive each type of sensitive information;
associating each outgoing e-mail with at least one authorization list;
comparing an e-mail address of each said outgoing e-mail to said at least one authorization list;
sending said outgoing e-mail to said addressee if the e-mail address is included in said at least one authorization list; or producing an alert if said e-mail address is not included in said at least one authorization list; and
requiring a further action before sending said outgoing e-mail.

17. The computer program product of claim 16, wherein said associating includes:
generating a request to designate at least one authorization list for each outgoing email.

18. The computer program product of claim 16, wherein said associating includes:
evaluating said outgoing e-mail message to detect sensitive information; and
associating said e-mail with an authorization list for the detected sensitive information.

19. The computer program product of claim 16, wherein said program code comprises:
restricting access to said assembling.

20. The computer program product of claim 16, wherein said further action comprises:
permitting said e-mail address to be added to said authorization list.

21. The computer program product of claim 16, wherein said further action comprises:
requiring an explicit override to authorize sending said outgoing e-mail.
